(19) United States
(12) Patent Application Publication
(10) Pub. No.: US 2016/0249116 A1
(43) Pub. Date: Aug. 25, 2016

(54) GENERATING MEDIA ASSET PREVIEWS BASED ON SCENE POPULARITY

(71) Applicant: ROVI GUIDES, INC., Santa Clara, CA (US)

(72) Inventor: Reda Harb, Bellevue, WA (US)

(21) Appl. No.: 14/631,753

(22) Filed: Feb. 25, 2015

(51) Int. Cl. H04N 21/8549; H04N 21/466; G11B 27/34; H04N 21/475

(52) U.S. Cl. CPC H04N 21/8549; H04N 21/4756; H04N 21/4667; H04N 21/4666; G11B 27/34

(57) ABSTRACT

Methods and systems are described herein provide for generating movie previews based on scene popularity. Scene popularity information is received from a plurality of users who indicate interest in each of a plurality of scenes identified by a respective user. The respective indications of interest are analyzed to determine a ranking metric for each of the plurality of scenes. A subset of the scenes having the highest ranking metrics are selected and assembled into a video clip preview.

### BACKGROUND OF THE INVENTION

Video clip previews for media assets are typically generated based on feedback from critics or based on pre-selected scenes, as chosen by editors. Under these systems, the video clip previews are generated independently of viewer input, and may include scenes that are not personalized or relevant to viewers.

### SUMMARY

Accordingly, systems and methods are disclosed herein for generating media asset previews based on scene popularity. By generating media asset previews, such as video clip previews, based on scene popularity, the previews can include scenes that are determined to be more relevant and engaging to viewers based on viewer input. In contrast, scenes selected by critics or editors may not reflect the interests of viewers.

For example, by way of the systems and methods disclosed herein, control circuitry may receive a first plurality of user inputs from a first user identifying a first set of scenes from a movie, “Planes” and a corresponding level of interest of the first user for each of the identified first set of scenes. The control circuitry may also receive a second plurality of user inputs from a second user identifying a second set of scenes from the same movie, and a corresponding level of interest of the second user for each of the identified second set of scenes. Control circuitry may then analyze the levels of interest for the identified first set of scenes and identified second set of scenes to determine a ranking metric for each of the scenes, by, for example, adding the level of interest of the first user and the level of interest of the second user for each of the scenes. Control circuitry may select the scenes having the ten highest ranking metrics, and assemble the selected scenes into a video clip preview. Control circuitry may transmit the video clip preview to a viewer in response to receiving a request to view a video clip preview for the movie, “Planes”.

In some aspects, by way of the systems and methods described herein, control circuitry (e.g., of a server) may receive from a first user a first plurality of inputs (e.g., input by a user input interface of a user equipment of the first user) identifying an indication of interest for each of a first plurality of scenes of a media asset. For example, control circuitry may receive from the first user, for each of the first plurality of scenes, an input indicating a start time for a scene of interest, an input indicating an end time for the scene of interest, and an indication of interest for the scene.

Control circuitry may receive, as the input indicating the start time for the scene of an interest, the start time itself, responsive to a user selection by the first user of a position on a navigational time bar for the media asset. Control circuitry may receive, as the input indicating the end time for the scene of interest, the end time itself, responsive to a user selection by the first user of a position on the navigational time bar for the media asset. Control circuitry may receive, as the indication of interest evaluation for the scene, one of several evaluation types (e.g., evaluation on an alphanumeric scale, binary evaluation, etc.). Control circuitry may receive an evaluation on an alphanumeric scale, such as a number from 0 to 9 (where higher numbers indicate higher interest) responsive to a user selection of a numerical value using an input device (e.g., a remote control or keyboard). Control circuitry may also or alternatively receive as an evaluation for the scene, a binary input indicating either interest or disinterest, in response to a user selection of an icon indicating “like or dislike” that is generated for display to the user along with the media asset by the control circuitry.

In some aspects, control circuitry may receive from a second user a second plurality of inputs (e.g., input by a user input interface of a user equipment of the second user) identifying an indication of interest for each of a second plurality of scenes of the media asset. For example, control circuitry may receive from the second user, for each of the second plurality of scenes, an input indicating a start time for a scene of interest, an input indicating an end time for the scene of interest, and an indication of interest for the scene. The inputs and indications of interest may be similar or a subset of those discussed above in reference to the first user.

In some aspects, control circuitry may analyze the indications of interest for the first plurality of scenes and the indications of interest for the second plurality of scenes to identify a ranking metric for each scene of the first plurality of scenes and the second plurality of scenes. For example, control circuitry may determine a set of overlapping scenes (e.g., scenes that have overlapping times) and a set of non-overlapping scenes (e.g., scenes not having overlapping times) by determining whether start and end times of any scenes overlap start and end times of any other scenes. Control circuitry may combine the overlapping scenes into a combined scene by taking the earliest start time among the overlapping scenes as the new start time of the combined scene and by taking the latest end time among the overlapping scenes as the new end time among the overlapping scenes. Control circuitry may calculate a ranking metric for each combined scene combining the indications of interest for each scene.

Control circuitry may determine whether the indications of interest from each user are a same type of evaluation or a different type of evaluation (e.g., if the indication of interest from a first user is a value on an alphanumeric scale, while the indication of interest from a second user is a binary input). If the indications of interest are the same evaluation type, control circuitry may add together the indications of interest for each of the overlapping scenes that constitute the combined scene, or taking a weighted average of the indications of interest where the weight is proportional to the duration of the constituent scene. If the indications of interest for each of the overlapping scenes are different evaluation types, control circuitry may normalize the evaluation types to a common reference line. For example, control circuitry may convert the binary value to a preset value on the alphanumeric scale.

In some aspects, control circuitry may identify a subset of the first plurality of scenes and the second plurality of scenes, where the subset of scenes include a predetermined number of items. For example, after determining a ranking metric for each scene of the first plurality of scenes and second plurality of scenes, control circuitry may rank the scenes according to the ranking metric, for example by highest ranking metric to lowest ranking metric. Control circuitry may retrieve the predetermined number of items for the subset from a default setting based on a desired length for a video clip preview. Control circuitry may also receive a user setting for the predetermined number of scenes that can vary based on a desired length for the video clip preview. If the desired length for the video clip preview (e.g., from the default setting or from the user setting) is three minutes, control circuitry may select ten scenes having the highest ranking metrics to fill a three minute video clip preview.

In some embodiments, control circuitry may assemble the subset of scenes into video clip preview. For example, control circuitry may further process the selected scenes to select a sub-scene if the scene was a combined scene. Control circuitry may select portions of the scene that relate to a favorite actor of a user by performing image recognition on frames of video the scene to identify the favorite actor, and select contiguous portions of video that include the identified actor. The selected scenes and sub-scenes may be ordered by related themes or characters and combined into a video clip preview.

In some embodiments, control circuitry may transmit a video clip preview for playback, in response to a request for a video clip preview. For example, control circuitry may, in response to receiving a request from a user to view a video clip preview, transmit the video clip preview to the user.

In some embodiments, the systems and methods described herein include, as the indication interest, at least one of plurality of evaluation types. For example, control circuitry may receive, as an evaluation type, an indication of like or dislike, and an evaluation on a scale. For example, control circuitry may receive from a user a selection of a graphical image indicating like or dislike for a scene of a media asset. This input provides a binary option for the user that is fast and simple. In addition or alternatively, control circuitry may receive from a user, as an evaluation type, an input value on a scale (e.g., 8 out of 9 on a 9 point scale) indicating interest in a media asset. The scale may include, among others, numerical scale, an alphabetic scale, or any other suitable scale. While the scaled value is more complicated than a binary option, but provides more resolution on a user's interests.

In some embodiments, control circuitry may operate on scenes that are defined by a uniform time duration. For example, each media asset may be divided into a number of uniform five minute intervals. For each scene having a uniform interval, control circuitry may receive no input from a user, or an input from a user as an indication of interest (e.g., whether a user is interested in a program). By using uniform intervals, control circuitry may receive only one input indicating an indication of interest for a media asset instead of receiving three inputs (e.g., one for start time, one for end time, and one for indication of interest), for each scene of interest.

In some embodiments, control circuitry operates on time durations based on a user definition of the time duration. For example, a user may identify a start scene time and an end scene time for durations of interest. For example, control circuitry may receive a first user input from a remote control that manipulates a cursor on a time bar to select a start time for a scene, and a second user input from the remote control that manipulates the cursor on the time bar to select an end time for the scene, and a third user input that selects an evaluation on a numeric scale (e.g., 5 on a 0-9 scale).

In some embodiments, control circuitry selects scenes from the first plurality of scenes and the second plurality of scenes that are related to at least one of a genre or parental control rating. For example, each video frame of a media asset may be tagged with an identifier of genre or parental control rating, for the content of that frame of video. Control circuitry may compare metadata from the frames of video defined and evaluated by viewers as scenes against a genre of the entire media asset. For example, a media asset may have a genre of action while some scenes have a corresponding genre of drama and other scenes have corresponding genre of action. Control circuitry may compare the genre of user defined and evaluated scenes (as extracted from the metadata of frames of video) with the genre of the media asset to find scenes for a video clip preview that match the genre for the media asset. For example, action scenes would be more suitable for a video clip preview of an action movie instead of drama clips.

In some embodiments, control circuitry receives an input that further identifies a keyword descriptor for one or more of the first plurality of scenes. For example, the control circuitry may receive a user indication of interest for a scene of the movie “Planes” (e.g., a selection of a start time, end time and a selection of a graphical icon on a screen”) and a keyword identifying a character in the scene (e.g., “Dusty”) (e.g., by receiving textual input entered via remote control). Control circuitry may store the keywords in storage locally on a user equipment for later display when generating the media asset for display and/or may transmit the keywords to a central server for storage.

In some embodiments, control circuitry may generate for display a plurality of scene identifiers where each of the plurality of scenes corresponds to a subset of the scenes identified and evaluated by a first user, and/or identified and evaluated by a second user. Control circuitry may generate for display one or more identified keyword descriptors for each scene of the subset. The control circuitry may generate for display a list of scene identifiers that are related by keyword. For example, control circuitry may generate for display a list of scenes from the movie “Planes”, which are tagged with a keyword for a character “Dusty”.

In some embodiments, control circuitry may generate for display a scene from a subset of scenes. Control circuitry may receive an indicator of interest in the scene from a third user, and modify a ranking metric of the scene. For example, control circuitry may generate for display a list of scenes to a user that are related a character from the movie, “Planes”, by the keyword “Dusty”. Control circuitry may further receive a request from a third user to view one of the scenes in the list. In response to receiving the request, control circuitry may generate for display the requested scene. Control circuitry may receive an indication of interest in the scene (e.g., an evaluation from 0-9). Control circuitry may modify a current ranking metric for the scene based on the indication of interest received from the third user. For example, control circuitry may re-compute the ranking metric as an average of the indication of interest from the first user, second user, and third user.

In some embodiments, the control circuitry may determine that a first user is within a trusted group of users (e.g., critics and/or editors) and in response, determine a ranking metric for each scene by weighting the trusted first user's indication more than other indications of interest. For example, control circuitry may receive a list of trusted users from a server. Control circuitry may have received a list of indications of interest for each of a same plurality of scenes from a media asset from two users, Alice and Bob. Control circuitry may determine that Bob is a member of the list of trusted users, and that Alice is not a member of the list of trusted users. In response to this determination, control circuitry may compute a ranking metric for each of the same plurality of scenes by providing twice as much weight to Bob's evaluation than to Alice's evaluation for a particular scene. For example, when computing a ranking metric where Alice has provided an evaluation of 4 out of 9, and Bob has provided an evaluation metric of 8 out of 9, a ranking metric would be 4+2*8/(3*9)=0.74, while a ranking metric, without weighing Bob's evaluation more heavily, would be 0.67.

In some embodiments, control circuitry determines that a third user is similar to the first user and less similar to the second user. The control circuitry may compare attributes of a user profile of the third user to a user profile of the first profile, and may compare attributes of a user profile of the third user to a user profile of the second user. The control circuitry may determine that the third user is more similar to the first user (e.g., based on similarity in age and hometown) and is less similar to the second user. The control circuitry may modify the ranking metric of the plurality of scenes selected by each of the first, second and third users by excluding the indications of interest from the second user. For example, if a scene had an indication of interest of 8 out of 9 by the first user, 8 out of 9 by the third user and 0 out of 9 by the second user, the control circuitry would determine the ranking metric as an average of 8 out of 9, because the control circuitry has excluded the second user from the calculations.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for selecting media assets in accordance with some embodiments of the disclosure;

FIG. 2 shows an illustrative media guidance application that may be used to adjust user settings in accordance with some embodiments of the disclosure;

FIG. 3 is a block diagram of an illustrative media system in accordance with some embodiments of the disclosure;

FIG. 4 is a block diagram of an illustrative media system in accordance with some embodiments of the disclosure;

FIG. 5 shows an illustrative display that can be generated for display to a user while viewing and evaluating scenes of a media asset in accordance with some embodiments of the disclosure;

FIG. 6 is a data structure that illustrates a first plurality of scenes identified by a first user, where each scene has a uniform time duration, and a corresponding indication of interest by the first user for each of the plurality of scenes in accordance with some embodiments of the disclosure;

FIG. 7 is a data structure that illustrates a second plurality of scenes identified by a second user, where each scene has a variable time duration, and a corresponding indication of interest by the second user for each of the plurality of scenes in accordance with some embodiments of the disclosure;

FIG. 8 is a data structure that illustrates a subset of scenes selected from the first plurality of scenes and the second plurality of scenes, a ranking metric for each of the plurality of scenes in the subset in accordance with some embodiments of the disclosure;

FIG. 9 is a data structure that illustrates a number of user profiles in accordance with some embodiments of the disclosure; and

FIG. 10 is a flow-chart of illustrative steps involved in generating media asset previews based on scene popularity in accordance with some embodiments of the disclosure.

### DETAILED DESCRIPTION

Systems and methods are disclosed herein for generating media asset previews based on scene popularity. By generating media asset previews, such as video clip previews, based on scene popularity, the previews can include scenes that are determined to be more relevant and engaging to viewers based on viewer input. In contrast, scenes selected by critics or editors may not reflect the interests of viewers.

For example, by way of the systems and methods disclosed herein, control circuitry may receive a first plurality of user inputs from a first user identifying a first set of scenes from a movie, “Planes” and a corresponding level of interest of the first user for each of the identified first set of scenes. The control circuitry may also receive a second plurality of user inputs from a second user identifying a second set of scenes from the same movie, and a corresponding level of interest of the second user for each of the identified second set of scenes. Control circuitry may then analyze the levels of interest for the identified first set of scenes and the identified second set of scenes to determine a ranking metric for each of the scenes, by, for example, adding the level of interest of the first user and the level of interest of the second user for each of the scenes. Control circuitry may select the scenes having the ten highest ranking metrics, and assemble the selected scenes into a video clip preview. Control circuitry may transmit the video clip preview to a viewer in response to receiving a request to view a video clip preview for the movie, “Planes”.

In some aspects, by way of the systems and methods described herein, control circuitry (e.g., of a server) may receive from a first user a first plurality of inputs (e.g., input by a user input interface of a user equipment of the first user) identifying an indication of interest for each of a first plurality of scenes of a media asset. For example, control circuitry may receive from the first user, for each of the first plurality of scenes, an input indicating a start time for a scene of interest, an input indicating an end time for the scene of interest, and an indication of interest for the scene.

Methods and systems are disclosed herein for generating media asset previews based on scene popularity, as evaluated by users viewing scenes and media assets. The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

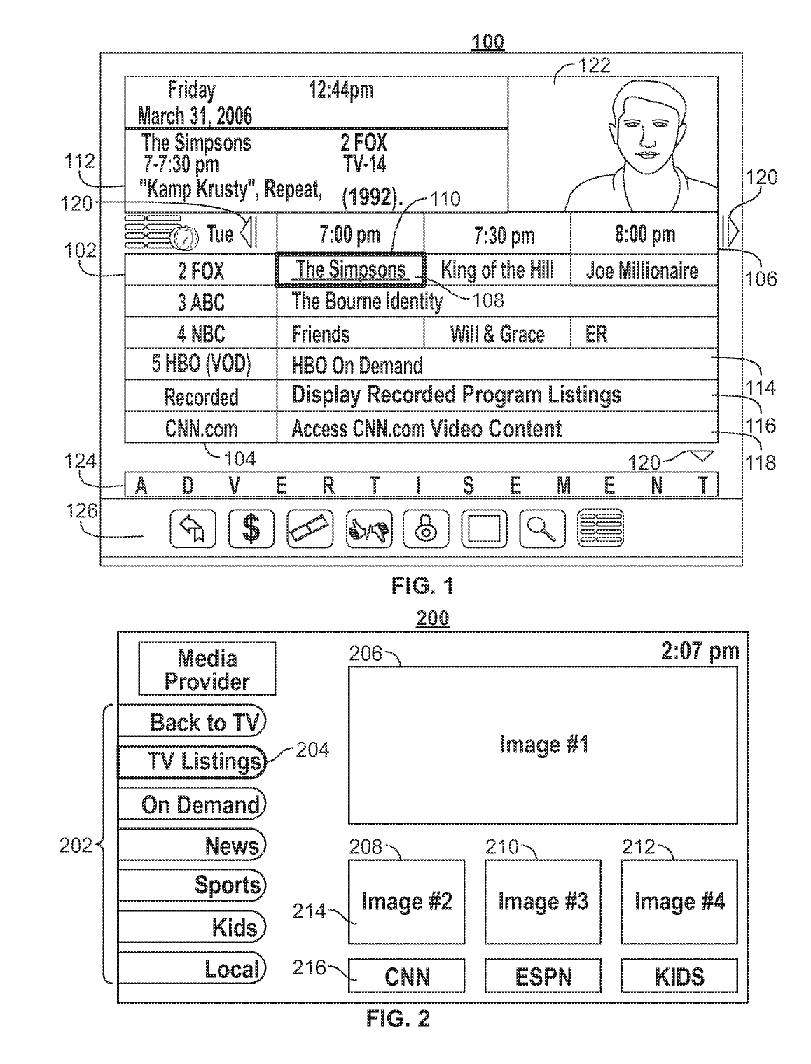

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

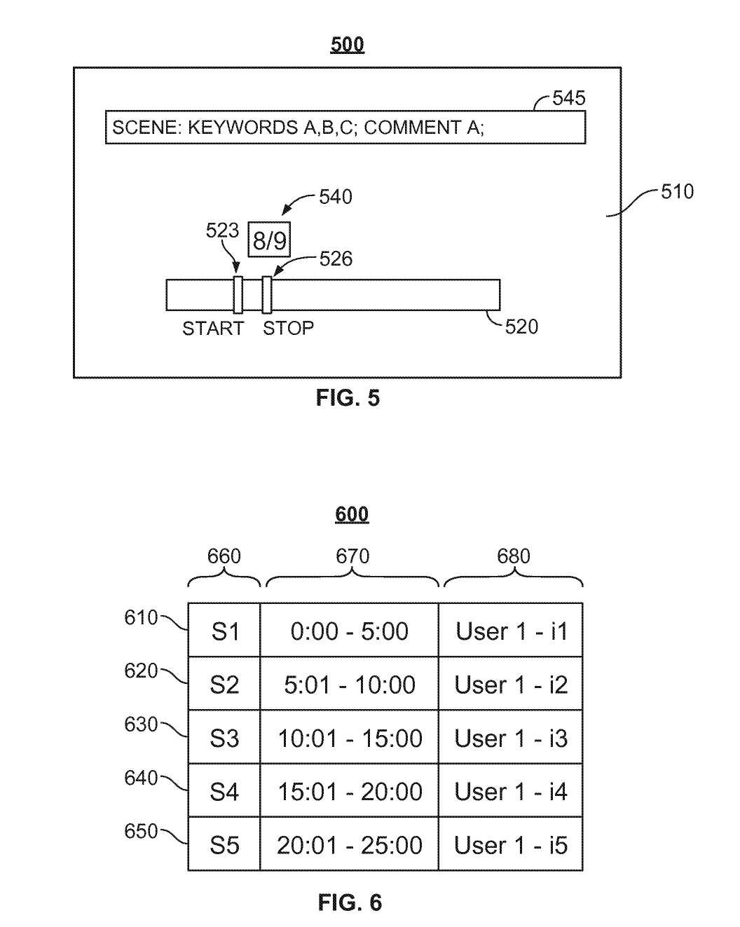

In some embodiments, media portion 214 may be a video clip preview of a media asset corresponding to listing 208. The preview of the media asset may be composed of one or more scenes selected from the media asset, based on the popularity of the scenes, determined from indications of interest by users in the scenes. In some implementations, as discussed further below in reference to FIG. 5, each user provides identifies and/or provides evaluations of scenes of a media asset while viewing the media asset. The identifications of the plurality scenes and corresponding indications of various users are collected and used to select scenes for the video clip preview, for example, based on a user profile of a user viewing the video clip preview, or a group of users viewing the video clip preview.

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

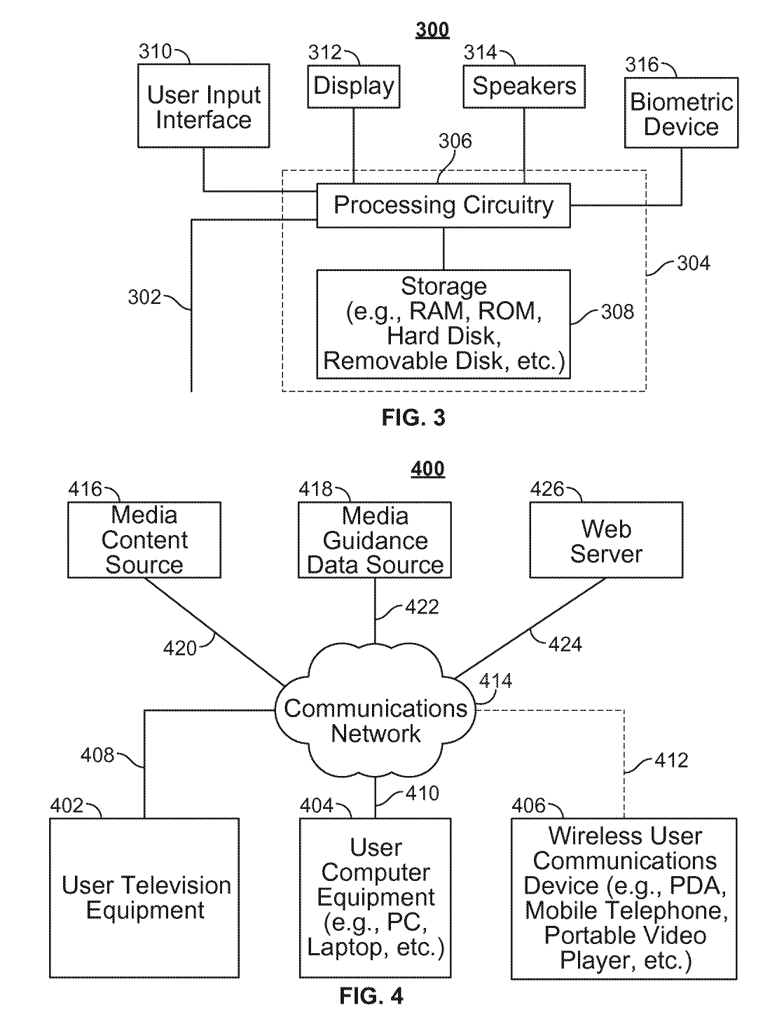

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

Control circuitry 304 of user equipment 300 may monitor biometric states of the user through biometric device 316, using any suitable biometric characteristic such as facial characteristics, body temperature characteristics, voice characteristics, behavioral recognition, or any other suitable biometric characteristic. Biometric device 316 may include one or more image capturing devices, video capturing devices, motion sensing devices, physiological sensing devices, neurological sensing devices or any other suitable biometric device. Motion, physiological, and neurological sensing devices may include wearable accelerometers, gyroscopes, multisensors, electroencephalograph sensors, electrocardiograph sensors, electromyograph sensors, and physiological sensors capable of detecting posture, body movement, heart rate, blood pressure, body temperature, respiration rate, brainwave, muscle contraction, and other motion, physiological, or neurological signals indicative of a user's emotional state. Motion, physiological, and neurological sensing devices may also include infrared, ultrasonic, microwave, magnetic, or tomographic motion, brainwave, and body temperature detectors that do not need to be worn directly by a user. Methods and systems of using motion, physiological and neurological sensing devices are described in U.S. patent application Ser. No. 14/329,656, which is hereby incorporated by reference herein in its entirety. In some embodiments, biometric device 316 may be included as part of user input device 310. For example, a user input device 310 may include a temperature sensor or a pulse sensor to measure physiological responses, for example to different scenes of a media asset while viewing the media asset. In some embodiments, biometric device 316 may be included as part of display 312. For example, a display 312 may include a camera that can store and measure facial characteristics of a user while the viewer is watching scenes of a media asset.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server (e.g., any of media content source 416, media guidance data source 418, or web server 426). For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application at each client collects user inputs identifying scenes and corresponding indications of interest by users, and transmits the collected information to a central database at a remote server. Control circuitry 304 at the remote server may then process the collected information from a plurality of users to identify scenes of interest for inclusion in a video clip preview for any users accessing the remote server system. In some embodiments, the media guidance application may operate on a local server (e.g., user equipment 300), and collect user inputs identifying scenes and corresponding indications of interest received from a plurality of users of the local server. Control circuitry 304 at the local server may then process the collected information from the plurality of users to identify scenes of interest for inclusion in a video clip preview for users of the local server system.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and web server 426 coupled to communications network 414 via communication paths 420, 422, and 424 respectively. Paths 420, 422 and 424 may include any of the communication paths described above in connection with paths 408, 410, and 412. Communications with the content source 416, media guidance data source 418, and web server 426, may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416, media guidance data source 418, and web server 426 may be integrated as one source device. Although communications between sources 416 and 418, and web server 426 with user equipment devices 402, 404, and 406 are shown as through communications network 414, in some embodiments, sources 416 and 418 and web server 426 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Web server 426 may host a website, social network, an internet database of information, or any other suitable online service. A web server may be any suitable computer equipment device as described above in reference to FIG. 3. In some embodiments, a web server may act as a media content source, for example as a streaming video website, or as a media guidance data source, for example, as a movie review website.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry (e.g., control circuitry 304) may analyze indications of interest for a first plurality of scenes identified by a first user and for a second plurality of scenes identified by a second user, in order to identify a subset of scenes for assembling into a video clip preview for a media asset. For example, control circuitry 304 may analyze the indications of interest for a first plurality of scenes identified by a first user for an episode of “Bubble Guppies”, and for a second plurality of scenes identified by a second user for the same episode of “Bubble Guppies”. Control circuitry 304 may then determine a ranking metric for each scene of the first plurality of scenes and the second plurality of scenes, by adding indications of interest from the first user and second user for overlapping scenes, and by taking the indication of interest from either of the first or second user for non-overlapping scenes. Control circuitry 304 may then select five scenes having the five highest ranking metrics and assemble these scenes into a video clip preview, that is transmitted to a user in response to a request received from the user to view a video clip preview for the episode of “Bubble Guppies”.

FIG. 5 shows an illustrative display 500 of a user equipment (e.g., user equipment 402, 404, and/or 406) that control circuitry 304 can generate for display to a user while generating a media asset for display to the user. Control circuitry 304 may receive evaluations of scenes of the displayed media asset from user input interface 310 of any of the user equipment in accordance with some embodiments of the disclosure. Display 500 may be generated for display to the user by way of display 312. Display 500 may include video 510, text region 545, media asset time bar 520, start scene indicator 523, end scene indicator 526 and interest indicator 540. Display 500 may be accessed, for example, in response to a user selection of a media asset (e.g., by way of user input interface 310) from any of display 100 in FIG. 1 or display 200 of FIG. 2. Video 510 may be generated for display by user equipment device 300 and corresponds to the selected media asset.

In some embodiments, control circuitry 304 may receive user input for defining a scene that is of interest to the user, and may additionally receive user input including the indication of interest for each scene that the user defines. Control circuitry 304 may generate for display media asset time bar 520 over video 510 using display 312. Control circuitry 304 may generate for display media asset time bar 520 for the purposes of indicating different time points of a media asset to facilitate definition of scenes by a user. For example, control circuitry 304 may detect user inputs (e.g., by way of user input interface 310) for defining a scene that includes a first user input indicating a start scene time and a second user input indicating a corresponding end scene time for a defined scene. In response to receiving the first user input, control circuitry 304 may generate for display start scene indicator 523. In response to receiving the second user input, control circuitry 304 may generate for display end scene indicator 526. As referred to herein, the term “defined scene” should be understood to mean any portion of a media asset, which has been indicated or selected by a user, that is delineated by a start time and end time.

Control circuitry 304 may receive an input (e.g., by way of user input interface 310) that corresponds to an indication of interest of the user in the scene defined by start scene indicator 523 and end scene indicator 526. Control circuitry 304 may generate for display interest indicator 530 (e.g., on display 312) to inform or prompt a user of an indication of interest that may be selected, or has been selected. In some implementations, control circuitry 304 may generate for display an interest indicator 540 that represents a binary state, either indicating interest or lack of interest (e.g., using a “like” icon or “dislike” icon). For example, control circuitry 304 may receive an input from a remote control that selects an icon, generated for display by control circuitry 304 on display 312, indicating “like” or “dislike” for a defined scene. Receipt of a selection of an icon indicating “like”, by control circuitry 304, may be an indication of interest from the user expressing interest in the defined scene. Receipt of a selection of an icon indicating “dislike”, by control circuitry 304, may be an indication of interest from the user that expresses that the user is not interested in the corresponding scene.

In some implementations, control circuitry 304 may generate for display an interest indicator 540 that represents a value on a scale (e.g., numerical, alphabetical or any other suitable scale), which provides more resolution for the interest of the user, rather than a binary state. For example, control circuitry 304 may receive an input from a remote control of a numerical evaluation of 8 on a scale of 0-9, which is an indication of interest from the user, indicating interest in the corresponding defined scene. As referred to herein, the term “indication of interest” should be understood to mean any input (e.g., selection or lack thereof of a graphic icon, textual representation, evaluation on an alphanumeric or other scale, or any other suitable selection) that corresponds to a user's interest (e.g., interest or disinterest corresponding to a selection or lack of selection of an icon; or level of interest corresponding to an evaluation on an alphanumeric scale).

In some implementations, control circuitry 304 may receive the input (e.g., by way of user input interface 310) representing the indication of interest of a user before, between, or after receiving the first and second inputs corresponding to the scene indicators 523 and 526, or any combination thereof. For example, control circuitry 304 may receive an input indicating interest before receiving an input indicating a start time of a scene and an input indicating an end time of a scene. For example, control circuitry 304 may receive a first input indicating a start time of a scene, a second input indicating an end time of a scene, and a third input representing an indication of interest. For example, control circuitry 304 may receive an input indicating a start time of a scene, an input representing an indication of interest in a scene starting at the start time, and an input indicating an end time of the scene.

In some implementations, control circuitry 304 may receive the user inputs identifying the start scene time, end scene time and indication of interest as active user interactions with a user input interface 310 (e.g., a selection of a key on a remote control device). In some implementations, the control circuitry 304 may receive user inputs that are passive user interactions, for example, by monitoring emotional states of a user. When an emotional state of a user corresponds to a happy state above a threshold, control circuitry 304 may set the start scene time. When the emotional state of the user corresponding to the happy state falls below a threshold, control circuitry 304 may set the end scene time and an indication of interest based on the emotional state.

In some embodiments of the present disclosure, a media asset may be subdivided into a number of scenes based on uniform time durations. For example, the media asset may be subdivided into scenes of five minute duration. Control circuitry 304 may receive a user input from a user setting the scene interval duration, or may use a default setting for a duration of scenes in a media asset. In some implementations, control circuitry 304 may receive indications of interest from a user only for scenes defined by the interval, whether a default interval or an interval specified by the user. In some implementations, control circuitry 304 determines a defined scene by receiving a user selection for a start time and a user selection for an end time of a scene.

In some embodiments of the present disclosure, the media asset may be divided into a number scenes having pre-defined variable time intervals. Control circuitry 304 may receive or request information about the pre-defined variable time intervals from any of media content source 416, media guidance data source 418 or web server 426 (each of which is accessible via communications network 414). Control circuitry 304 may store the received information in storage 308. In some implementations, control circuitry 304 receives the information about the pre-defined variable time intervals as part of the media asset. For example, control circuitry 304 may receive the media asset as a digital video stream having embedded tags indicating start times or start packets of the stream for scenes, and end times or end packets of the stream for scenes. For example, control circuitry 304 may receive a file or stream, separate from the media asset that includes a number of start scene times and end scene times. Control circuitry 304 may receive the start scene and end scene information that has been pre-defined for example by a number of critics, editors, or by a production team for the media asset. The user is able to set an indication of interest for each of these scenes using any of the processes described above.

In some embodiments of the present disclosure, control circuitry 304 may generate for display text region 545. Control circuitry 304 may generate text region 545 that includes one or more keyword descriptors A, B, or C corresponding to a scene, and/or one more or comments corresponding to each keyword descriptor. In some implementations, control circuitry 304 may receive a keyword descriptor that is a hashtag set by a user when providing an indication of interest in a displayed scene. For example, control circuitry 304 of a user equipment device may receive an input from user input interface 310 indicating a keyword and/or a comment that is associated with a scene identified by the user. Control circuitry 304 may receive the input as an indication of interest in the scene, or may be received in addition to an indication of interest. Control circuitry 304 may store the keywords and/or comments in storage 308 of user equipment device 300 or may transmit the keywords and/or comments in storage, using input/output path 302, to any of media content source 416, media guidance data source 418 and web server 426 for storage.

In some implementations, control circuitry 304 may generate for display a scene for a user, and may additionally generate for display text region 545 to include keywords and/or comments that have been received from other users for the same scene. For example, control circuitry 304 of user equipment device 306 may generate for display video 510 of a scene. The control circuitry 304 may determine that other users have previously set keyword descriptors and/or comments for the scene, and generate for display the set of keyword descriptors and/or comments for the scene. Control circuitry may determine that other users have previously set keyword descriptors and/or comments for the scene by querying local storage for keywords or comments set for a scene, or by receiving information about scenes including keywords/comments by other users from any of media content source 416, media guidance data source 418 and web server 426.

In some implementations, control circuitry 304 updates text region 545 while generating for display a media asset or corresponding scene. For example, first control circuitry 304 of a first user equipment may generate for display a media asset to a first user while second control circuitry 304 of a second user equipment may also generate for display the same media asset to a second user at the same time. First control circuitry 304 may receive an indication of interest from the first user, which is or includes a keyword descriptor and/or comment for the media asset. In response to receiving the indication of interest from the first user including the keyword descriptor and/or comment, first control circuitry 304 may transmit the indication of interest including the keyword descriptor and/or comment to one or more of media content source 416, media guidance data source 418 and/or web server 426. Second control circuitry may retrieve indications of interest including the keyword descriptors and/or comments from one or more of media content source 416, media guidance data source 418 and/or web server 426. Second control circuitry may subsequently update text region 545 for the second user to include the keyword descriptor and/or comment that was set by the first user for the same scene.

In some embodiments, control circuitry may generate for display a plurality of scene identifiers where each of the plurality of scenes corresponds to a subset of the scenes identified and evaluated by a first user, and/or identified and evaluated by a second user. Control circuitry may generate for display one or more identified keyword descriptors for the each scene of the subset. In response to receiving a user selection of a scene, or a keyword descriptor (e.g., receiving a selection of a keyword descriptor within text region 545), the control circuitry may generate for display a list of scene identifiers that are related by keyword. For example, control circuitry may generate for display a list of scenes from the movie “Planes”, which are tagged with a keyword for a character “Dusty” or that are tagged with a keyword for the movie “Planes”.

In some embodiments, control circuitry may generate for display a scene from a subset of scenes. Control circuitry may receive an indicator of interest in the scene from a third user, and modify a ranking metric of the scene. For example, control circuitry may generate for display a list of scenes to a user that are related a character from the movie planes by the keyword “Dusty”. Control circuitry may further receive a request from a third user to view one of the scenes in the list. In response to receiving the request, control circuitry may generate for display the requested scene. Control circuitry may receive an indication of interest in the scene (e.g., an evaluation from 0-9). Control circuitry may modify a current ranking metric for the scene based on the indication of interest received from the third user. For example, control circuitry may re-compute the ranking metric as an average of the indication of interest from the first user, second user, and third user.

Although one display 500 has been illustrated, it should be understood that in a multiuser system, there may be multiple instances of display 500 displayed to each of the users of the system. In some embodiments, a user may use multiple user equipment devices. For example, first control circuitry 304 of user television equipment 402 may generate a media asset for display, while second control circuity 304 of a wireless user communications device 406 may receive an indication of a start scene time, end scene time, and indication of interest from a user.

FIG. 6 is a data structure 600 that illustrates a first plurality of scenes identified by a first user, where each scene has a uniform time duration, and a corresponding indication of interest by the first user for each of the plurality of scenes, in accordance with some embodiments of the disclosure. Data structure 600 may include three columns: scene indices 660, scene durations 670, and indications of interest 680. Data structure 600 may include one or more rows of records. For example, data structure 600 may include rows 610, 620, 630, 640, and 650. In some implementations, each row may correspond to a scene of interest identified by a user and an indication of the user's interest in the scene. Control circuitry 304 of user equipment devices 402, 404, and 406, or media content source 416, media guidance data source 418, or web server 426 may generate and maintain data structure 600 to record and keep track of a user's indications of interest in one or more defined scenes. Control circuitry 304 may generate data structure 600 to include only one row if control circuitry 304 has only received one user indication of interest. Control circuitry 304 may generate data structure 600 to include multiple rows if control circuitry 304 has received more than one user indication of interest in a scene from a user.

Scene indices column 660 may include a scene index for each row. Scene durations column 670 may include a start time and stop time for each row to identify the corresponding scene. For example, control circuitry 304 may generate data structure 600 so that each of the scenes is a uniform five minutes in duration, as indicated by the durations in the rows of scene durations column 670. Control circuitry may generate data structure 600 so that indications of interest column 680 may include an indication of interest in a scene corresponding to the duration in column 670 of the same row. As discussed above in reference to FIG. 5, control circuitry 304 may receive an indication of interest as a binary value (e.g., indicating like or dislike of a scene), or as a value on a scale (e.g., numerical scale 0-9, alphabetical scale a-z, etc).

Control circuitry 304 of user equipment device 300 may generate data structure 600 of FIG. 6, responsive to receiving user inputs identifying scenes of interest and corresponding indications of interest. For example, in reference to FIG. 5, control circuitry 304 of user equipment device 300 may generate a record in row 610 in response to receiving a user indication of interest during a first five minute duration of a media asset. Control circuitry 304 may subsequently receive user indications of interest during subsequent five minute durations of the media asset and generate the subsequent rows 620 through 650. In some embodiments, control circuitry 304 of user equipment device 300 may continually monitor emotional responses to scenes of five minute duration (or any other fixed interval) and may generate additional records in data structure 600 to include indications of interest for each interval.

In some embodiments, control circuitry 304 may store data structure 600 on user equipment device 300 in storage 308. In some implementations, control circuitry 304 of user equipment 300 may transmit the data structure 600 to a server (e.g., media content source 416, media guidance data source 418, web server 426, or any other suitable server) for storage and processing on the server.

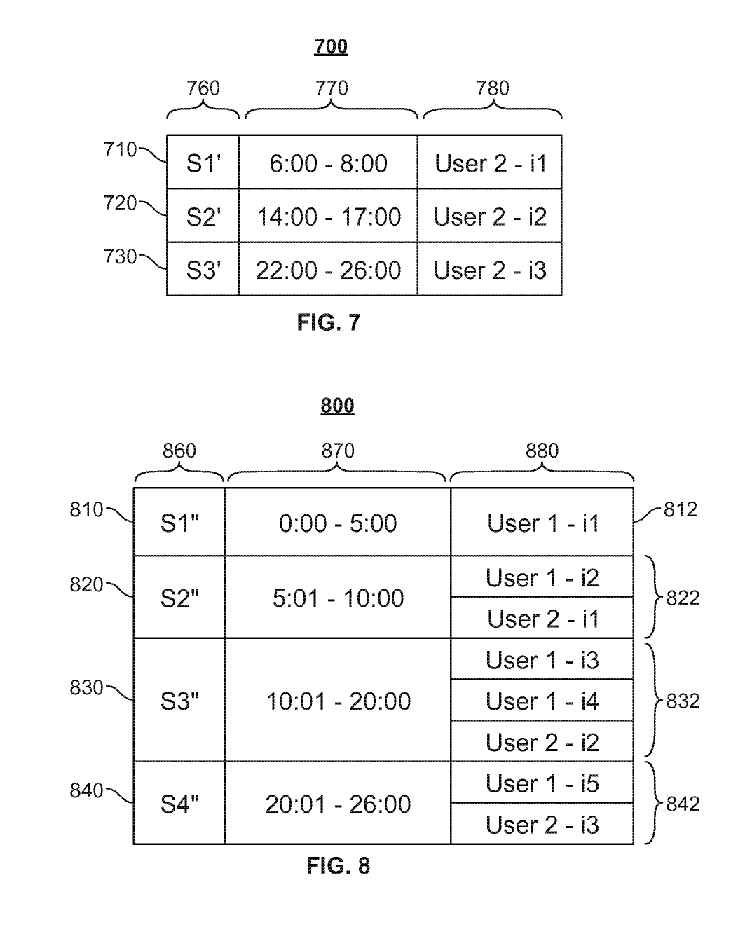

FIG. 7 is a data structure 700 that illustrates a second plurality of scenes identified by a second user, where each scene has a variable time duration, and a corresponding indication of interest by the second user for each of the plurality of scenes in accordance with some embodiments of the disclosure. Data structure 700 may include three columns, corresponding to the columns in data structure 600: scene indices 760, scene durations 770, and indications of interest 780. Data structure 700 may include one or more rows of records. For example, data structure 700 may include rows 710, 720, and 730. In some implementations, each row may correspond to a scene of interest identified by a user and an indication of the user's interest in the scene. Control circuitry 304 of user equipment devices 402, 404, and 406, or media content source 416, media guidance data source 418, or web server 426 may generate and maintain data structure 700 to record and keep track of a user's indications of interest in one or more defined scenes. Control circuitry 304 may generate data structure 700 to include only one row if control circuitry 304 has only received one user indication of interest. Control circuitry 304 may generate data structure 700 to include multiple rows if control circuitry 304 has received more than one user indication of interest in a scene from a user.

Scene indices column 760 may include a scene index for each row. Scene durations column 770 may include a start time and stop time for each row to identify the corresponding scene. For example, control circuitry 304 of user equipment 300 may receive user inputs defining start scene times and stop scene times for a plurality of scenes having non-uniform durations, in contrast to the uniform durations of data structure 600, as indicated by the non-uniform durations in the rows of scene durations column 770. Indications of interest column 780 may include an indication of interest in a scene corresponding to the duration in column 770 of the same row. The indication of interest may be a binary value (e.g., indicating like or dislike of a scene), or may indicate a value on a scale (e.g., numerical scale 0-9, alphabetical scale a-z, etc).

Control circuitry 304 of user equipment device 300 may generate data structure 700 responsive to receiving user inputs identifying scenes of interest and corresponding indications of interest. For example, in reference to FIG. 5, control circuitry 304 of user equipment device 300 may generate a record in row 710 in response to receiving a first user indication identifying a start time for a scene (e.g., 6:00), corresponding to start scene indicator 523, and a second user indication identifying a end time for the scene (e.g., 8:00) corresponding to end scene indicator 526. Control circuitry 304 may receive a user indication of interest for the scene, corresponding to interest indicator 540.

Control circuitry 304 may subsequently receive a second set of user indications identifying a start scene time 14:00 and end scene time 17:00, with an indication of interest corresponding to user2-i2, and create row 720 to store information about this identified scene. Control circuitry 304 may similarly generate row 730 in response to another set of inputs.

In some embodiments, control circuitry 304 may store data structure 700 on user equipment device 300 in storage 308. In some implementations, control circuitry 304 of the user equipment device may transmit the data structure 700 to a server (e.g., media content source 416, media guidance data source 418, web server 426, or any other suitable server) for storage and processing on the server.

FIG. 8 is a data structure that illustrates a subset of scenes selected from the first plurality of scenes and the second plurality of scenes, a ranking metric for each of the plurality of scenes in the subset in accordance with some embodiments of the disclosure. Control circuitry 304 of a server may generate data structure 800 in response to analyzing a first plurality of scenes identified by a first user, stored in data structure 600, and a second plurality of scenes identified by a second user, stored in data structure 700. Data structure 800 may include three columns, corresponding to the columns in data structure 600 and data structure 700: scene indices 860, scene durations 870, and ranking metric 880. Data structure 800 may include one or more rows of records. For example, data structure 800 may include rows 810, 820, 830, and 840.

In some implementations, each row may correspond to a scene of interest determined from the analysis of the first plurality of scenes of data structure 600 and the second plurality of scenes of data structure 700. For example, control circuitry 304 of a server may identify overlapping and non-overlapping scenes from the first plurality of scenes and second plurality of scenes. As referred to herein, the term “overlapping scenes” should be understood to refer to two defined scenes having overlapping start times and/or end times. Control circuitry 304 may copy or move information from the non-overlapping rows into data structure 800 (e.g., information from row 610 having scene index S1 is copied into row 810 having scene index S1″).

Control circuitry 304 may combine information from overlapping scenes into rows in data structure 800. In reference to FIG. 6 and FIG. 7, control circuitry 304 may combine row 620 having scene index S2 and row 720 having scene index S1′ are combined into row 820 having scene index S2″.

Control circuitry 304 may take the start scene time and end scene time of the union of the scene durations as the new scene duration (e.g., 5:01 as the start scene time and 10:00 for the end scene time for scene S2″, based on the times from S2 and S2′). Control circuitry 304 may likewise combine Scene S3 of row 630, Scene S4 of row 640 and Scene S2′ of row 720 into scene S3″ of row 830, and may likewise combine Scene S5 of row 650 and Scene S3′ of row 730 into Scene S4″ of row 840.

The control circuitry 304 for a server (e.g., media content source 416, media guidance data source 418, and/or web server 426) may determine a ranking metric for each of the scenes in data structure 800. Data structure 800 illustrates four ranking metrics 812, 822, 832 and 842. The ranking metric may include each of the indications of interest from the constituent scenes, a corresponding identity of a user who indicated interest in the scene. In some implementations the ranking metric may include a single value, generated based on the indications of interest from the constituent scenes. For example, control circuitry 304 may calculate an average of all indications of interest from constituent scenes, or a weighted average of the indications of interest based on the corresponding length of the constituent scenes.

In some embodiments, control circuitry may determine whether the indications of interest from each user are a same type of evaluation or different type of evaluation (e.g., if the indication of interest from a first user is a value on an alphanumeric scale, while the indication of interest from a second user is a binary input). If the indications of interest are the same evaluation type, control circuitry may add together the indications of interest for each of the overlapping scenes that constitute the combined scene, or taking a weighted average of the indications of interest where the weight is proportional to the duration of the constituent scene. If the indications of interest for each of the overlapping scenes are different evaluation types, control circuitry may normalize the evaluation types to a common reference line. For example, control circuitry may convert the binary value to a preset value on the alphanumeric scale. Although the generation of data structure 800 has been discussed in reference to a control circuitry of a server, it should be understand that the discussions also apply to control circuitry of a local server, or a user equipment device.

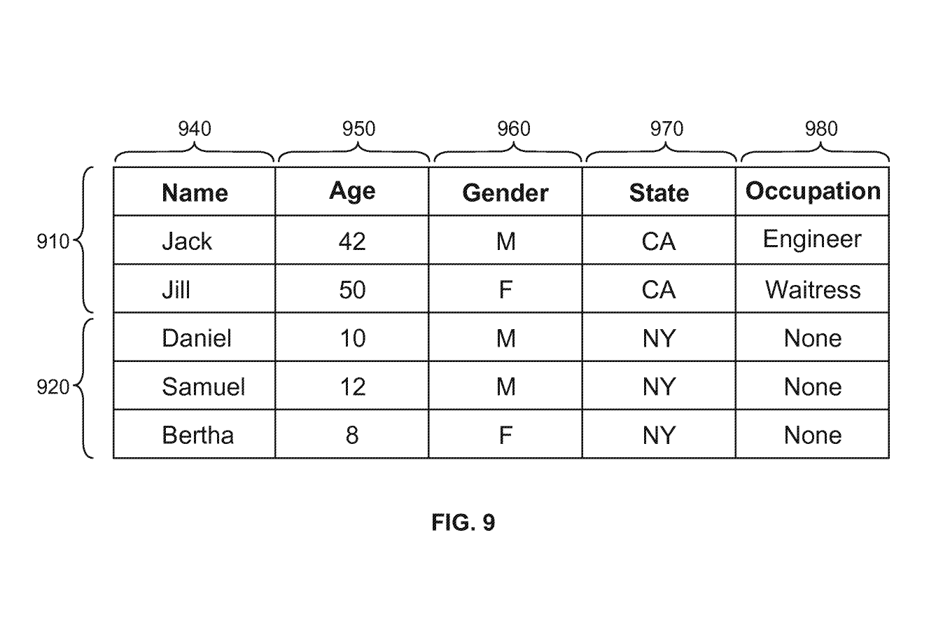

FIG. 9 is a data structure 900 that illustrates a number of user profiles in accordance with some embodiments of the disclosure. Data structure 900 may include five information columns: (a) name column 940, (b) age column 950, (c) gender column 960, (d) state column 970, and (e) occupation column 980. Data structure 900 may include one or more rows, where each row corresponds to a user profile. In some implementations, control circuitry 304 of a server (e.g., media content source 416, media guidance data source 418, and/or web server 426) or user equipment may select groups of users the rows based on information in the user profiles, and may generate video clip previews for each group based on user indications from members of the same group. For example, group 910 may correspond to an adults group based on age, and group 920 may correspond to a children group based on age. Control circuitry 304 of user equipment (e.g., user equipment device 300, a remote server 200, a local server, or any other suitable device in response to inputs from users) may generate data structure 900. Control circuitry 304 of user equipment 300 or servers 416, 418, 426 may transfer the data structure 900, and may be stored at any user equipment devices or servers. Although data structure 900 has been illustrated with five information columns, it should be understood that data structure may include more columns that have information, such as user preferences for media assets (e.g., based on actors, genre, etc.).

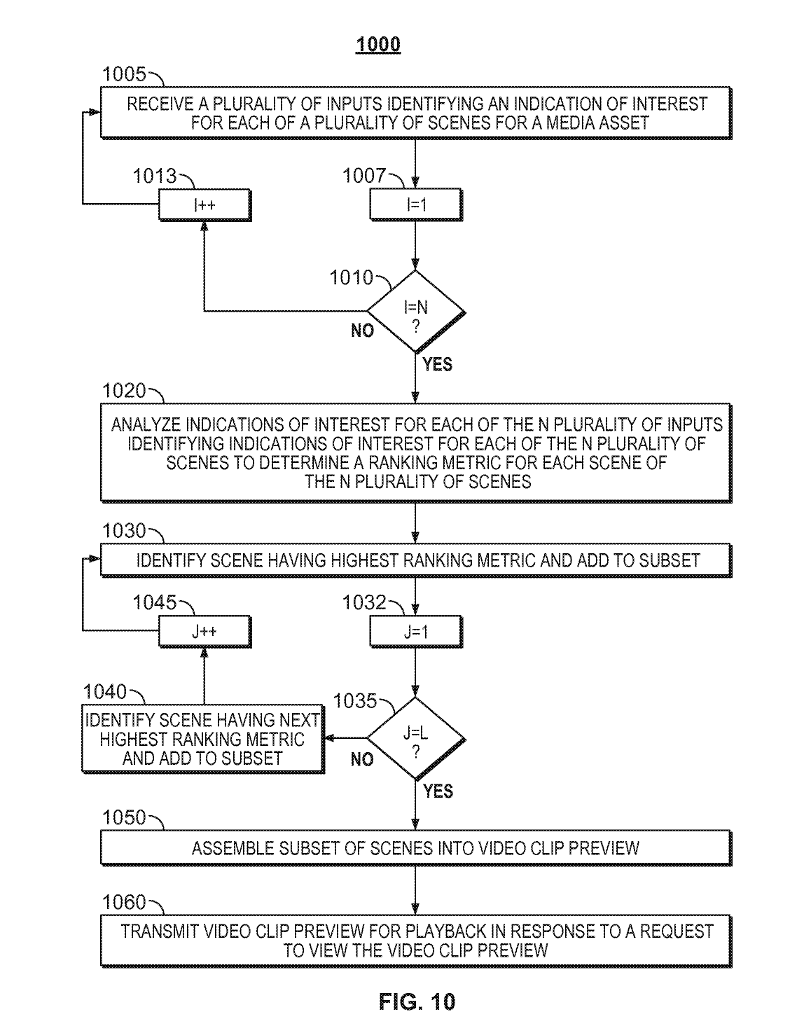

FIG. 10 is a flowchart of illustrative steps involved in generating media asset previews based on scene popularity, determined from user indications of interest in scenes identified by a plurality of users, in accordance with some embodiments of the disclosure. It should be noted that process 1000 or any step thereof could be performed on, or provided by, any of the devices shown in FIGS. 3-4. For example, process 1000 may be executed by control circuitry 304 (FIG. 3) as instructed by control circuitry implemented on user equipment 402, 404, and/or 406 (FIG. 4) in order to receive a plurality of inputs identifying an indication of interest for each of a plurality of scenes for a media asset. In addition, one or more steps of process 1000 may be incorporated into or combined with one or more steps of any other process or embodiment.

FIG. 10 is a flow-chart 1000 of illustrative steps involved in generating media asset previews based on scene popularity in accordance with some embodiments of the disclosure. Although the following steps of flow-chart 1000 will be discussed as predominantly being performed by a control circuitry 304 of a remote server, it should be understood that each and any of the illustrative steps described in flow-chart 1000 may be performed by control circuitry at web server 426, control circuitry of user equipment device 300, any other suitable server or source, and/or a any combination thereof.

In some embodiments, at step 1005, control circuitry 304 of a remote server receives a plurality of inputs identifying an indication of interest for each of a plurality of scenes for a media asset (e.g., scenes for an episode of the TV show “Bubble Guppies”). At step 1007, the control circuitry 304 of the remote server initializes an index i to 1. Index i may be used to count a number of users from which a plurality of inputs identifying the scenes have been received. At step 1010, the control circuitry 304 of the remote server checks whether the index i has reached a threshold N. In some implementations, N may be equal to a number of users accessing the evaluation system. In some implementations, N may be equal to a number of users accessing a particular media asset (e.g. “Bubble Guppies”). If control circuitry 304 determines that the index i has not reached the threshold N, the process proceeds to step 1013, otherwise the process proceeds to step 1020. At step 1013, control circuitry 304 of the remote server increments the index i. The process then proceeds to step 1005.

At step 1020, control circuitry 304 analyzes the indications of interest for each of the N plurality of inputs identifying indications of interest for each of the N plurality of scenes to determine a ranking metric for each scene of the N plurality of scenes. In some implementations, control circuitry 304 may consolidate the scenes based on the start scene and end scene times as discussed above in reference to generation of data structure 800 of FIG. 8.

In some embodiments, the control circuitry may determine that a first user is within a trusted group of users (e.g., critics and/or editors) and, in response, determine a ranking metric for each scene by weighting the trusted first user's indication more than other indications of interest. For example, control circuitry may receive a list of trusted users from a server. Control circuitry may have received a list of indications of interest for each of a same plurality of scenes from a media asset from two users, Alice and Bob. Control circuitry may determine that Bob is a member of the list of trusted users, and that Alice is not a member of the list of trusted users. In response to this determination, control circuitry may compute a ranking metric for each of the same plurality of scenes by providing twice as much weight to Bob's evaluation than to Alice's evaluation for a particular scene. For example, when computing a ranking metric where Alice has provided an evaluation of 4 out of 9, and Bob has provided an evaluation metric of 8 out of 9, a ranking metric would be 4+2*8/(3*9)=0.74, while a ranking metric without weighing Bob's evaluation more heavily would be 0.67.

At step 1030, control circuitry 304 identifies a scene having the highest ranking metrics and adds the scenes to a subset. At step 1032, control circuitry 304 sets an index j to 1. Index j may be used to count a number of scenes selected for the subset. In some embodiments, although a scene has a high ranking metric, control circuitry may not select the scene because the subject matter of the scene is not relevant to the overall genre of the movie. A romantic scene may not be as informative for a video clip preview about an action movie. For example, control circuitry 304 may compare a genre associated with the identified scene with a genre for the movie. If there is a mismatch, the control circuitry 304 does not add the identified scene to the subset, and retrieves and checks the scene having the next highest ranking metric.

For example, each video frame of a media asset may be tagged with an identifier of genre or parental control rating, for the content of that frame of video. Control circuitry may compare metadata from the frames of video defined and evaluated by viewers as scenes against a genre of the entire media asset. A media asset may have a genre of action while some scenes have a corresponding genre of drama and other scenes have a corresponding genre of action. Control circuitry may compare the genre of user defined and evaluated scenes (as extracted from the metadata of frames of video) with the genre of the media asset to find scenes for a video clip preview that match the genre for the media asset. Action scenes would be more suitable for a video clip preview of an action movie instead of drama clips. Control circuitry may also compare genre, parental control rating or any other suitable ratings information, category information, guidance data, or any combination thereof, associated with an identified scene and with a media asset.

In some embodiments, an identified scene may not be added to a subset based on a parental control rating for a target group of viewers. A video clip preview trailer for children may be different for a video clip preview trailer for adults. For example, control circuitry 304 may compare a parental control rating associated with an identified scene with a parental control rating associated with a target group or target user. If control circuitry 304 determines that a parental control rating associated with the identified scene exceeds a parental control rating associated with a target group of viewer or with a group of users, control circuitry 304 does not add that preview to the subset, and retrieves the next scene.

At step 1035, control circuitry 1035 checks whether the index j has reached a threshold L. In some implementations L may be a minimum number of scenes selected for a video clip preview. In some implementations, L may be variable depending on the intended target of the video clip preview (e.g., a specific user or a group of users). If the index j has reached a threshold L, the process proceeds to step 1050, otherwise the process proceeds to step 1040. At step 1040, the control circuitry 304 identifies a scene having the next highest ranking metric and adds it to the subset. At step 1045, the control circuitry increments the index j.

At step 1050, the control circuitry 304 assembles a subset of scenes into a video clip preview. In some embodiments, the selected scenes from step 1030 are further processed to reduce the playback time of the scenes. For example, combined scenes from overlapping scenes from a first plurality of scenes identified by a first user and from a second plurality of scenes identified by a second user may have a length that is longer than suitable for a video clip preview. In some implementations, the selected scenes may be shortened by selecting the shortest constituent scene from the combined scene. For example, in reference to FIG. 8, combined scene S3″ is composed of scenes S3, S4 and S2′. Control circuitry 304 may select scene S2′ as the shortest of the three constituent scenes.

In some implementations, the selected scenes may be shorted by selecting constituent scenes that more closely match a target group of users or a targeted group of users. For example, in reference to a video clip preview targeting an adult group, control circuitry 304 may compare the ages of the adult group 910 from FIG. 10 with user profiles of users that identified the constituent scenes, and select the constituent scene selected by a user that matches closest in age to the adult group.

In some embodiments, the scenes based on combined non-overlapping scenes or independent overlapping scenes may have a length that is too long for the video clip preview. For example, control circuitry may have received from a user a start scene time and an end scene time corresponding to a scene that is too long (e.g., 15 minutes), control circuitry may have received a setting of a uniform time duration that is too long (e.g., 10 minutes), or control circuitry may have received pre-selected scenes that are be too long. In some implementations, control circuitry 304 may shorten the scenes by selecting a sub-portion, based on metadata tags or processing of the video frames and audio frames of the video, that includes an actor that is most relevant to a group of users or a specific user. For example, control circuitry 304 may examine metadata associated with the video of the scene to select frames of video that have been tagged with a certain actor. For example, control circuitry 304 may perform graphical processing on the frames of video to identify actors using facial recognition or other biometric recognition to identify a portion of the scene that is related to an actor. Control circuitry 304 may perform audio processing to identify audio frames of the video that include the voice of an actor, and determine the corresponding video frames. Control circuitry 304 may select the portions of the scene having an actor or actors that match to the favorites of a target group of users or a single user.

In some embodiments, the selected frames may be assembled into a video clip preview in chronological or non-chronological order. For example, control circuitry 304 may determine that some target groups of users may have a preference for a certain actor by comparing a favorite actor attribute in user profiles of the user (e.g., user profiles illustrated in FIG. 9). Control circuitry 304 may select scenes related to that actor and order the scenes based on the popularity of the scenes instead of based on the chronological order of the scenes.

At step 1060, the control circuitry 304 transmits the video clip preview for playback in response to receiving a request to view the video clip preview. In some embodiments, the video clip preview may be generated and available for viewing in response to a receipt of a viewer selection of an identifier of the media asset in a media guidance application. For example, control circuitry 304 may receive a user selection of any of listings 206, 208, and 210 and transmit the video clip preview to the user for viewing. In some embodiments, the video clip preview may be generated and available for viewing in response to a receipt of a viewer selection from a web page of videos. For example, control circuitry 304 may receive a user selection of a media asset identifier for the video clip preview from a web page, and transmit the video clip preview to the viewer.

In some embodiments, control circuitry 304 may generate the video clip preview, just-in-time, in response to receiving a request (e.g., through user input interface 310) to view a video clip preview from a viewer, instead of being generated prior to receiving the request to view the video. The just-in-time creation may offer highly customized video clip previews based on the user profile of the requesting viewer. For example, control circuitry 304 of a server may receive a request from a user to view a video clip preview for a media asset. The request may include an identification of the user. Control circuitry 304 of the remote server may retrieve a user profile of the requesting user, and analyze the sets of indications of interest received by a plurality of users, and further analyze only those sets of indications of interest that correspond to users who are similar to the requesting user. Control circuitry 304 may then determine a ranking metric based on identified scenes from users that best match the user, where indications of interest from users that are more similar to the requesting user are weighted more than indications of interest from users that are less similar to the requesting user, in determining a ranking metric for each scene of the plurality of identified scenes.

In some embodiments, control circuitry 304 determines that a third user is similar to a first user and less similar to the second user. The control circuitry may compare attributes of a user profile of the third user to a user profile of the first profile, and may compare attributes of a user profile of the third user to a user profile of the second user. The control circuitry may determine that the third user is more similar to the first user (e.g., based on similarity in age and hometown) and is less similar to the second user. The control circuitry may modify the ranking metric of the plurality of scenes selected by each of the first, second and third users by excluding the indications of interest from the second user. For example, if control circuitry received an indication of interest of 8 out of 9 by the first user for a scene, 8 out of 9 by the third user for the scene and 0 out of 9 by the second user for the scene, the control circuitry may determine the ranking metric as an average of 8 out of 9, because control circuitry has excluded the second user from the calculations.

In some embodiments, control circuitry 304 determine ranking metric by weighing indications of interest from a first user more than indications of interest from a second user, in response to determining that a third user is more similar to the first user, and that the third user is less similar to the second user. For example, if control circuitry receives an indication of interest of 8 out of 9 by the first user for the scene, and 0 out of 9 by the second user for the scene, and control circuitry has determined based on a comparison of user profile attributes that the third user is more similar to the first user and that the third user is less similar to the second user, the control circuitry may determine the ranking metric by weighting the indication of interest from the second user 0.10 and weighting the indication of interest from the first user as 0.90, resulting in an average of 7.2 out of 9, instead of 4, if the indications of interest from the first user and second user were weighted equally.

Control circuitry 304 may subsequently select a number of scenes having the highest ranking metric, and further process the selected scenes as needed to reduce the playback time of each scene as discussed above, and assemble the scenes into a video clip preview that is transmitted to the requesting viewer. Although the generation of a video clip preview has been discussed in a just-in-time context for one user, it should be understood that the generation may be performed for a target group of users instead of an individual user, and may also be performed in a non just-in-time context.

In some embodiments, scenes or combined scenes from any of the plurality of scenes may be posted to a web page for transmittal to requesting viewers. The posting of individual scenes may facilitate further feedback upon sub-portions of the scenes or popularity of whole scenes. For example, control circuitry 304 of a server may receive a user selection of any of the displayed scenes, and generate for display a modified display 500 of FIG. 5 that permits the user to evaluate sub-portions of the scene. Control circuitry 304 may further use indications of interest for these sub-portions of scenes in the selection of scenes or shortening of combined scenes, for a video clip preview.

It is contemplated that the steps or descriptions of FIG. 10 may be used with any other embodiment of this disclosure. In addition, the steps and descriptions described in relation to FIG. 10 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 10.

It will be apparent to those of ordinary skill in the art that methods involved in the present invention may be embodied in a computer program product that includes a computer-usable and/or readable medium. For example, such a computer-usable medium may consist of a read-only memory device, such as a CD-ROM disk or conventional ROM devices, or a random access memory, such as a hard drive device or a computer diskette, having a computer-readable program code stored thereon. It should also be understood that methods, techniques, and processes involved in the present invention may be executed using processing circuitry. For instance, determination of media asset ranking may be performed by processing circuitry, e.g., by processing circuitry 306 of FIG. 3. The processing circuitry, for instance, may be a general purpose processor, a customized integrated circuit (e.g., an ASIC), or a field-programmable gate array (FPGA) within user equipment 300, media content source 416, media guidance data source 418, or web server 426. For example, the media asset attributes as described herein may be stored in, and retrieved from, storage 308 of FIG. 3, or media guidance data source 418 of FIG. 4. Furthermore, processing circuitry, or a computer program, may update settings associated with a user, such as user profile preferences, updating the information stored within storage 308 of FIG. 3 or media guidance data source 418 of FIG. 4.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method comprising:
receiving from a first user, a first plurality of inputs identifying an indication of interest for each of a first plurality of scenes of a media asset;
receiving, from a second user, a second plurality of inputs identifying an indication of interest for each of a second plurality of scenes of the media asset;
analyzing the indications of interest for the first plurality of scenes and the indications of interest for the second plurality of scenes to determine a ranking metric for each scene of the first plurality of scenes and the second plurality of scenes;
identifying a subset of the first plurality of scenes and the second plurality of scenes, wherein the subset comprises a predetermined number of scenes;
assembling the subset of scenes into a video clip preview; and
transmitting the video clip preview for playback, in response to a request to view the video clip preview.

2. The method of claim 1, wherein each indication of interest for each of the first plurality of scenes is identified by a user input comprising at least one of an indication of like or dislike, and a value on a scale.

3. The method of claim 1, wherein each of the first plurality of scenes and the second plurality of scenes are defined by a uniform time duration.

4. The method of claim 1, wherein each of the first plurality of scenes is identified based on a user indication of a time duration for each scene from the first user and wherein each of the second plurality of scenes is identified based on a user indication of a time duration for each scene from the second user.

5. The method of claim 1, wherein the first plurality of scenes and the second plurality of scenes are selected from a set of scenes of the media asset that is related to at least one of a genre or parental control rating.

6. The method of claim 1, wherein the first plurality of inputs further identifies a keyword descriptor for one or more of the first plurality of scenes.

7. The method of claim 6, further comprising:
generating for display a plurality of scene identifiers, wherein each of the plurality of scene identifiers corresponds to one of the subset of scenes; and
generating for display one or more identified keyword descriptors corresponding to each scene of the subset of scenes.

8. The method of claim 7, further comprising:
generating for display, a scene from the subset of scenes corresponding to the selected media asset scene identifier;
receiving, from a third user, an indication of interest in the scene;
modifying a ranking metric corresponding to the scene based on the indication of interest received from the third user.

9. The method of claim 1, wherein analyzing the indications of interest for the first plurality of scenes and indications of interest for the second plurality of scenes further comprises:
determining that the first user is a member of a trusted group of users, and the second user is not a member of a trusted group of users; and
in response to the determination, determining the ranking metric for each scene by weighting the indications by the first user more than the indications by the second user.

10. The method of claim 1, further comprising:
determining that a third user is similar to the first user;
determining that the third user is dissimilar to the second user; and
in response to determining that the third user is similar to the first user, and that the third user is dissimilar to the second user, assembling the subset of scenes based on the indications from the first user, but not the second user, and user profile information of the third user.

11. A system comprising:
an input/output path; and
control circuitry configured to:
receive from a first user, a first plurality of inputs identifying an indication of interest for each of a first plurality of scenes of a media asset;
receive, from a second user, a second plurality of inputs identifying an indication of interest for each of a second plurality of scenes of the media asset;
analyze the indications of interest for the first plurality of scenes and the indications of interest for the second plurality of scenes to determine a ranking metric for each scene of the first plurality of scenes and the second plurality of scenes;
identify a subset of the first plurality of scenes and the second plurality of scenes, wherein the subset comprises a predetermined number of scenes;
assemble the subset of scenes into a video clip preview; and
transmit the video clip preview for playback using the input/output path, in response to receiving, from the input/output path a request to view the video clip preview.

12. The system of claim 11, wherein each indication of interest for each of the first plurality of scenes is identified by a user input comprising at least one of an indication of like or dislike, and a value on a scale.

13. The system of claim 11, wherein each of the first plurality of scenes and the second plurality of scenes are defined by a uniform time duration.

14. The system of claim 11, wherein each of the first plurality of scenes is identified based on a user indication of a time duration for each scene from the first user and wherein each of the second plurality of scenes is identified based on a user indication of a time duration for each scene from the second user.

15. The system of claim 11, wherein the first plurality of scenes and the second plurality of scenes are selected from a set of scenes of the media asset that is related to at least one of a genre or parental control rating.

16. The system of claim 11, wherein the first plurality of inputs further identifies a keyword descriptor for one or more of the first plurality of scenes.

17. The system of claim 16, wherein the control circuitry is further configured to:
generate for display a plurality of scene identifiers, wherein each of the plurality of scene identifiers corresponds to one of the subset of scenes; and
generate for display one or more identified keyword descriptors corresponding to each scene of the subset of scenes.

18. The system of claim 17, wherein the control circuitry is further configured to:
generate for display, a scene from the subset of scenes corresponding to the selected media asset scene identifier;
receive, from a third user, an indication of interest in the scene;
modify a ranking metric corresponding to the scene based on the indication of interest received from the third user.

19. The system of claim 11, wherein the control circuitry is further configured to:
determine that the first user is a member of a trusted group of users, and the second user is not a member of a trusted group of users; and
in response to the determination, determine the ranking metric for each scene by weighting the indications by the first user more than the indications by the second user.

20. The system of claim 11, further comprising:
determine that a third user is similar to the first user;
determine that the third user is dissimilar to the second user; and
in response to determining that the third user is similar to the first user, and that the third user is dissimilar to the second user, assembling the subset of scenes based on the indications from the first user, but not the second user, and user profile information of the third user.

21-50. (canceled)
